(19) United States
(12) Patent Application Publication
(10) Pub. No.: US 2005/0063645 A1
(43) Pub. Date: Mar. 24, 2005

(54) Device for gripping optical fibers

(75) Inventors: James B. Carpenter, Austin, TX (US); Vern E. Radewald, Austin, TX (US); Sidney J. Berglund, Round Rock, TX (US); George W. Parrett, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/668,401

(22) Filed: Sep. 23, 2003

(51) Int. Cl. G02B 6/38; G02B 6/255

(52) U.S. Cl. 385/70; 385/95; 385/136

(57) ABSTRACT

An optical fiber gripping device comprises first and second members hingedly attached at a first end of each of the members. A gripping region is provided and includes first and second gripping portions disposed on first and second inner portions of each of the members, respectively, to apply a substantially even distribution of force to an outer perimeter of an optical fiber disposed in the gripping region. The optical fiber gripping device provide a mechanical splicing tool for splicing, gripping, and/or connecting protective coated fibers.

### BACKGROUND OF THE INVENTION

1. Field of the Invention

The present invention is directed to a device for gripping optical fibers. In particular, the present invention is directed to a device for gripping optical fibers having a protective coating, such as a polymer-based coating.

2. Related Art

Mechanical devices for splicing optical fibers for the telecommunications industry are known. For example, U.S. Pat. No. 5,159,653 describes an optical fiber splice that includes a sheet of ductile material having a focus hinge that couples two legs, where each of the legs includes a V-type groove to optimize clamping forces for conventional glass optical fibers. The described splice device has been commercially incorporated in the FIBRLOK II™ mechanical fiber optic splice device, available from 3M Company, of Saint Paul, Minn. In addition, U.S. Pat. No. 5,337,390 describes an adhesiveless connector, with a connector body and ferrule attached to one another, with a mechanical gripping element residing in the connector body to hold an optical fiber in place. The gripping element described therein is engageable by moving a plug in a direction transverse to bores formed in the connector body and ferrule. The described connector has been commercially incorporated in the CRIMPLOK™ fiber optic connector, available from 3M Company, of Saint Paul, Minn. Conventional devices are also described in U.S. Pat. Nos. 4,824,197; 5,102,212; 5,138,681; and 5,155,787.

These conventional products typically utilize deformable v-groove technology to achieve fiber alignment and retention. This technology involves the displacement of element material, conventionally a ductile or malleable material such as aluminum, by the glass optical fiber. Glass is robust when exposed to compressive forces and can accomplish the displacement of the soft aluminum v-groove without compromising its own structure.

However, other fiber compositions are useful for optical applications. For example, U.S. Pat. No. Re. 36,146 describes an optical fiber element (referred to herein as “GGP fiber”) that includes a protective coating affixed to the glass optical fiber that remains on the glass optical fiber during splicing or connectorization. This protective coating, which can protect underlying layers from abrasion, cracking, and mechanical damage, can comprise a polymer-based coating that does not have the robustness of glass when exposed to compressive forces.

### SUMMARY OF THE INVENTION

According to a first aspect of the present invention, an optical fiber gripping device comprises a sheet of material having first and second members hingedly attached at a first end of each of the members. A gripping region is also provided and includes first and second gripping portions disposed on first and second inner portions of each of the members, respectively, to apply a substantially even distribution of force to an outer perimeter of an optical fiber disposed in the gripping region.

According to another aspect of the present invention, an optical fiber splice comprises a first optical fiber having a first end, where a protective coating is affixed to a cladding layer. The splice further comprises a second optical fiber having a second end, where the protective coating of the first end contacts the second end. Also, a housing supports the first and second ends in contact, where the housing applies a substantially even distribution of force to an outer perimeter of the first and second optical fibers.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The present invention will be further described with reference to the accompanying drawings, wherein:

FIG. 1 shows a side elevational view of an optical fiber gripping device according to a first embodiment of the present invention;

FIG. 2 shows a perspective view of an optical fiber gripping device according to a first embodiment of the present invention;

FIG. 3 shows a top plan view of an optical fiber gripping device in an unfolded orientation according to a first embodiment of the present invention;

FIG. 4 shows a cross-sectional view of an optical fiber having a protective coating;

FIGS. 5A and 5B show close-up views of an optical fiber gripping device according to a first embodiment of the present invention in open and closed positions, respectively, and FIGS. 5C and 5D show close-up views of a conventional gripping device gripping a standard glass optical fiber in open and closed positions, respectively;

FIG. 6A shows a finite element analysis (FEA) showing the compressive stress generated in an optical fiber using a conventional gripping device with a v-groove gripping region and FIG. 6B shows a FEA showing the compressive stress generated in an optical fiber using an optical fiber gripping device according to a first embodiment of the present invention;

FIGS. 7A-7D show schematic views of a pre-grooving process according to another embodiment of the present invention;

FIGS. 8A and 8B show alternative views of a pre-grooving process according to an alternative embodiment of the present invention and FIGS. 8C and 8D show open and closed spliced positions according to yet another embodiment of the present invention;

FIGS. 9A and 9B show alternative embodiments of the present invention, namely optical fiber gripping devices having double and quadruple slot configurations; and

FIGS. 10A-10B show side elevational views of an optical fiber gripping device according to another embodiment of the present invention, FIG. 1C shows a top plan view of said optical fiber gripping device, and FIGS. 10D and 10E show side views of the optical fiber gripping device in an unfolded state prior to and after pre-grooving, respectively.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

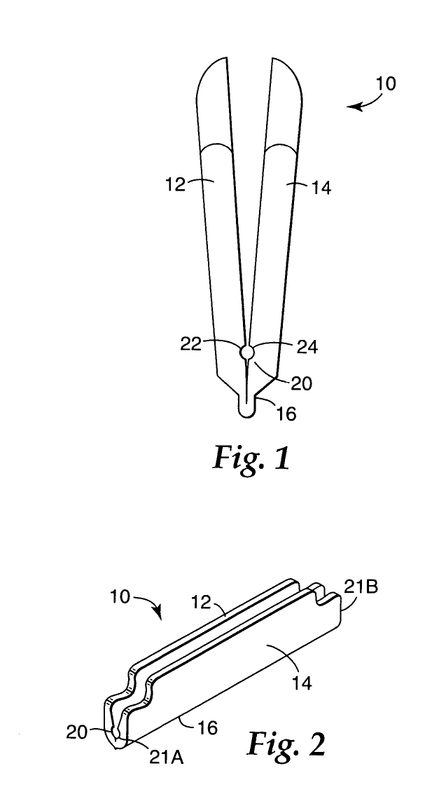

FIGS. 1-3 show an optical fiber gripping device according to a first embodiment of the present invention. The terms “gripping”, “splicing” or “connecting” may be applied to device 10, and are not intended to be mutually exclusive, as the devices and methods of the present invention can be utilized for fiber gripping, fiber splicing, and fiber connecting applications. The term “splice” should not be construed in a limiting sense since element 10 can indeed allow removal of a fiber.

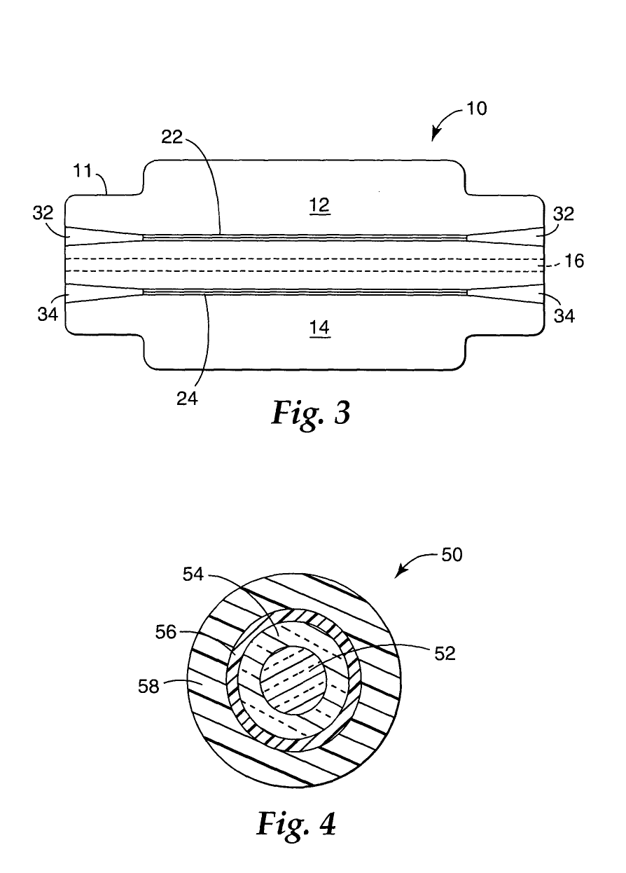

In FIGS. 1 and 2, device 10 is shown in a folded state and in FIG. 3, device 10 is shown in an unfolded state. Gripping device 10 includes a first member 12 and a second member 14 formed from a sheet of material 11 hingedly attached at a first end of each of the members, here shown as hinge region 16. A gripping region 20 is also provided and includes first gripping portion 22 and second gripping portion 24 disposed on first and second inner portions of each of the members. Gripping region 20 is adapted to receive an optical fiber in its gripping portions. In an exemplary embodiment of the present invention, gripping device 10, when placed in a closed (engaged) state, can apply a substantially even distribution of force to an outer perimeter of the optical fiber(s) disposed in the gripping region.

The dimensions of sheet 11 may vary considerably depending upon the application. Gripping device 10 can be formed from a sheet 11 of deformable material, preferably a ductile metal such as aluminum. An exemplary material is an aluminum alloy conventionally known as “3003”, having a temper of 0 and a hardness on the Brinnell scale (BHN) of between 23 and 32. Another acceptable alloy is referred to as “1100”, and has a temper of 0, H14 or H15. Acceptable tensile strengths vary from 35 to 115 megapascals. Other metals and alloys, or laminates thereof, may be used in the construction of sheet 11. Such metals include copper, tin, zinc, lead, indium, gold and alloys thereof. In addition, a polymeric material, clear or opaque, may be used for sheet 11. Suitable polymers include polyethylene terephthalate, polyethylene terephthalate glycol, acetate, polycarbonate, polyethersulfone, polyetheretherketone, polyetherimide, polyvinylidene fluoride, polysulfone, and copolyesters such as VIVAK (a trademark of Sheffield Plastics, Inc., of Sheffield, Mass.).

With further reference to FIGS. 1-3, a hinge region 16 can be formed on an outside surface of sheet 11, extending generally the length of sheet 11. Hinge region 16 can comprise a centrally located groove that can be formed of an area of reduced thickness which defines a hinge that separates sheet 11 into two identical plate-like members or legs 12 and 14. Such a hinge can be formed in the manner described in U.S. Pat. No. 5,159,653, incorporated by reference herein in its entirety. In its folded state, the embodiment of gripping device 10 is configured to be insertable in an optical fiber splice, such as a FIBRLOK II™ mechanical fiber optic splice device.

For example, gripping device 10 may be preloaded in the folded state (although not in the closed, engaging state) in an optical splice connector body in the manner described in U.S. Pat. No. 5,159,653. Such a splice connector body can include a base and a cap. As the cap is moved from an open position to a closed position, two cam bars can slide over legs 12 and 14, urging them toward one another. In an exemplary embodiment, rounded edges along the outside surface of legs 12 and 14 can facilitate a camming action.

In one embodiment of the present invention, both of the members or legs have a gripping region that respectively comprise gripping portions or grooves 22 and 24 on the inside surface of sheet 11. In an exemplary embodiment, the gripping portions are formed in a pre-grooving process, as described in further detail below. The gripping portions or grooves 22 and 24 are configured to provide mechanical compressive forces that are uniformly applied to the outer diameter of a fiber, such as a protective coated fiber. Such substantially evenly distributed compressive forces can help ensure one or more of the following: coating integrity, coating reliability, optical performance (e.g., optimal axial alignment between two fibers held in the device), and mechanical fiber retention for the lifetime of the device (e.g., splice or connector).

In exemplary embodiments, grooves 22 and 24 are each substantially semi-circular in shape and are generally parallel with hinge region 16, and equidistant therefrom. In some applications, it is not necessary for the grooves that comprise gripping portions 22 and 24 to extend the full length of sheet 11. For example, as shown in FIG. 3, concave recesses 32 and 34 can be formed to lie adjacent grooves 22 and 24, respectively, whereby, when legs 12 and 14 are folded together (as shown in FIG. 1), recesses 32 and 34 form a lead-in fiber receiving region or cone for an optical fiber, such as fiber 50, shown in FIG. 4.

Protective-coated optical fiber 50, for example, can include a glass core 52, a glass cladding 54, a protective coating 56, and a layer 58. In a conventional GGP fiber, such as the embodiments described in U.S. Pat. No. Re. 36,146, layer 58 is removed and the protective coating 56 remains affixed to the glass fiber (core/clad) during connectorization. In this example, the outer diameter of the protective coating 56 is about 125 μm, where the layer 56 has a thickness of about 12.5 μm, surrounding about a 100 μm diameter glass core/clad. As described below, fibers having protective coatings and outer diameters of greater than or less than 125 μm can be utilized with the present invention. In addition, as will be apparent to one of ordinary skill in the art given the present description, the devices and methods of the present application can be utilized to grip, splice, and/or connect alternative optical fibers, including conventional glass-based fibers, POF (Plastic Optical Fiber), and TECS (Technically Enhanced Clad Silica) fiber. These fibers may have several standard diameters (including buffer coatings) of about 125 μm (with or without a buffer coating being removed), 250 μm outer diameter, and/or 900 μm outer diameter, as well as nonstandard diameters in between 125 μm and 900 μm, and larger.

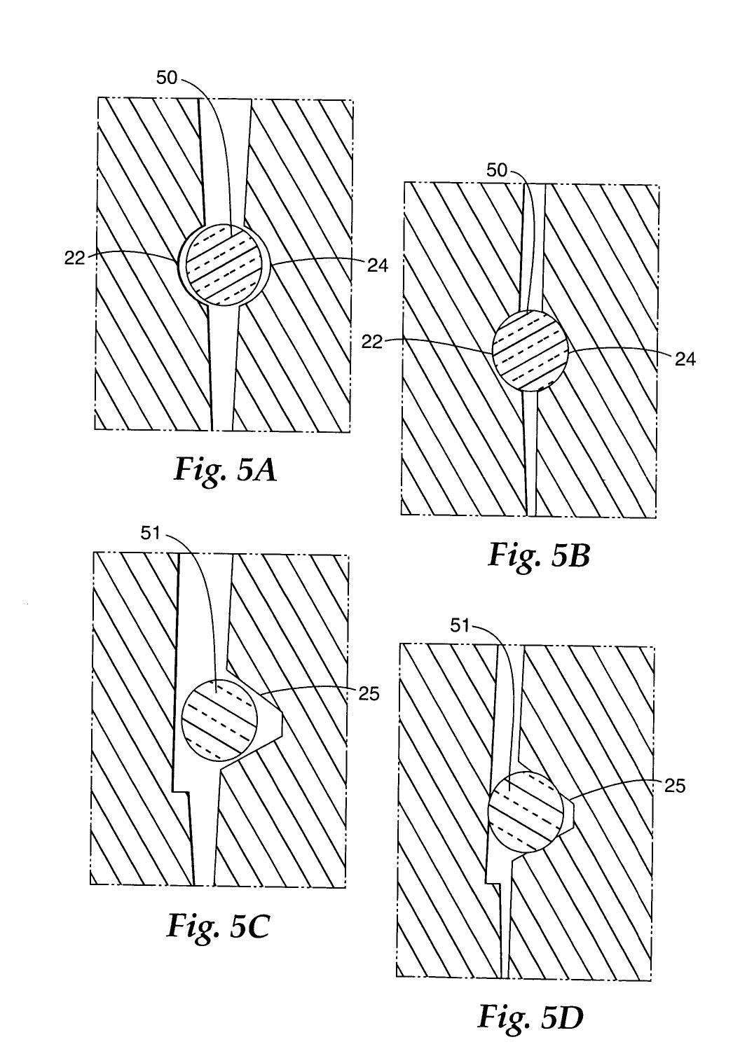

Referring now to FIGS. 5A and 5B, close-up schematic views of the optical fiber gripping device 10 are depicted in its open (fiber-receiving) and closed (fiber-gripping) states. As shown in FIG. 5A, a fiber 50 is received in the gripping region between gripping portions 22 and 24. The open position provides sufficient clearance for the insertion of one or more fibers into device 10. When gripping device 10 is placed in a closed or engaged position, as shown in FIG. 5B, the outer surface of the fiber can be contacted on about 240 degrees to about 360 degrees of its perimeter by the fiber gripping portions. For example, as shown in FIG. 5B, the gripping portions contact about 312 degrees of the outer perimeter of fiber 50. In another example, a fiber can be contacted on about 340 degrees of its outer diameter. In this exemplary embodiment, the substantially semicircular geometry allows each of the gripping portions to be diametrically aligned to ensure substantially even compressive force distribution along the perimeter of the fiber. In addition, when the fiber is contacted on 350 degrees or more of its outer diameter, delamination of a protective coated fiber (e.g., a GGP fiber) into the openings between the gripping portions can be greatly reduced.

As a comparison, FIGS. 5C and 5D show close-up schematic views of a conventional aluminum fiber splice device having a v-groove gripping region 25 in its open (fiber-receiving) and closed (fiber-gripping) states. The v-groove provides coarse alignment of the fiber in the open position. In the closed position, the gap between fiber gripping portions is narrower, and the fiber becomes partially embedded into the v-groove on at least one side of the element. As shown in FIG. 5D, high compressive forces are created when the gripping region 25 is closed around a glass optical fiber 51 at three points. Using a glass fiber 51, the aluminum is displaced, thereby reshaping the original fiber alignment/retention geometry.

For these conventional v-groove based products, if a protective-coated fiber (e.g., having a polymer-based coating) is inserted in gripping region 25, the protective coating can crack under the compressive loads, either on a splice or under later temperature cycling, thereby degrading connectivity and/or optical performance. Further, concentrated or localized forces on a protective coating could generate fiber misalignment over time.

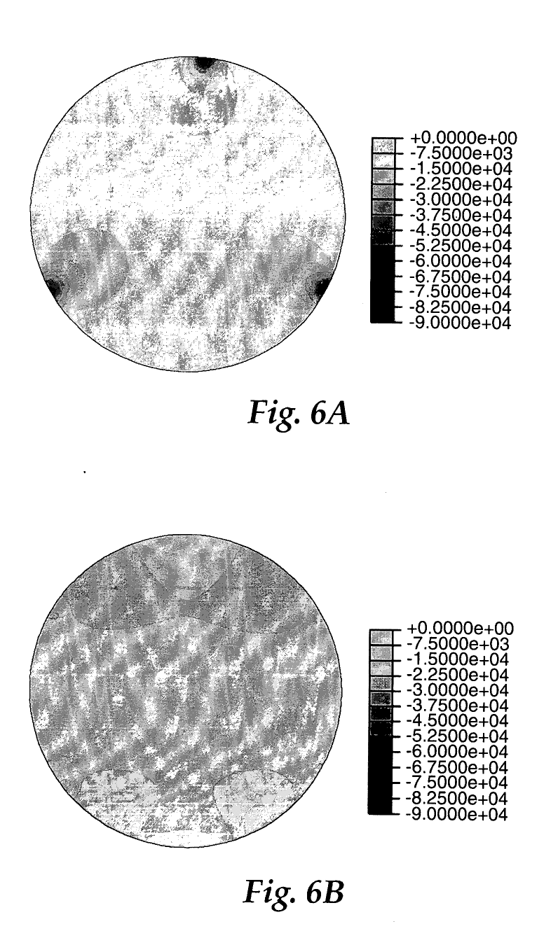

As illustrated in FIGS. 6A and 6B, the gripping region of the gripping device 10 can provide a significant improvement over a conventional v-groove configuration by providing substantially evenly distributed compressive forces that can help ensure e.g., coating integrity, coating reliability, optical performance, and/or mechanical fiber retention for the lifetime of the device. FIG. 6A shows a simulation, specifically a Finite Element Analysis (FEA), that represents the compressive stress generated in a 125 μm glass fiber held with a conventional v-groove type mechanical splicing device. Three distinct areas are shown having a high concentration of compressive stress, with a maximum compressive stress calculated to be −89,224 psi. In contrast, using an exemplary semicircular design for the gripping portions of a gripping device, as is described above, FIG. 6B shows a FEA that represents a substantially evenly distributed compressive stress placed on a 125 μm glass fiber, with a maximum compressive stress calculated to be −23,902 psi. Thus, the FEA analysis illustrates that the maximum compressive stress placed on a fiber can be significantly reduced (here, in this example, by a factor of about 2.73) when utilizing a gripping device according to exemplary embodiments of the present invention.

A process for forming the gripping region of the gripping device is referred to herein as pre-grooving. In an exemplary embodiment, this process utilizes a precise, predetermined diameter pin that is harder than the material comprising the gripping portion. The pin is inserted in the gripping region in a predetermined position. The device 10 is then closed to a predetermined position to form the substantially semicircle shapes of gripping portions 22 and 24. This pre-grooving process can ensure precise and reliable alignment of the semi circular grooves because variations in the hinge region 16 may occur during hinge folding. With conventional processes used to fold legs 12 and 14 about the hinge region, offsets of about 0.001″ to about 0.002″ can occur. Thus, the pre-grooving process can maintain optimal alignment between legs 12 and 14.

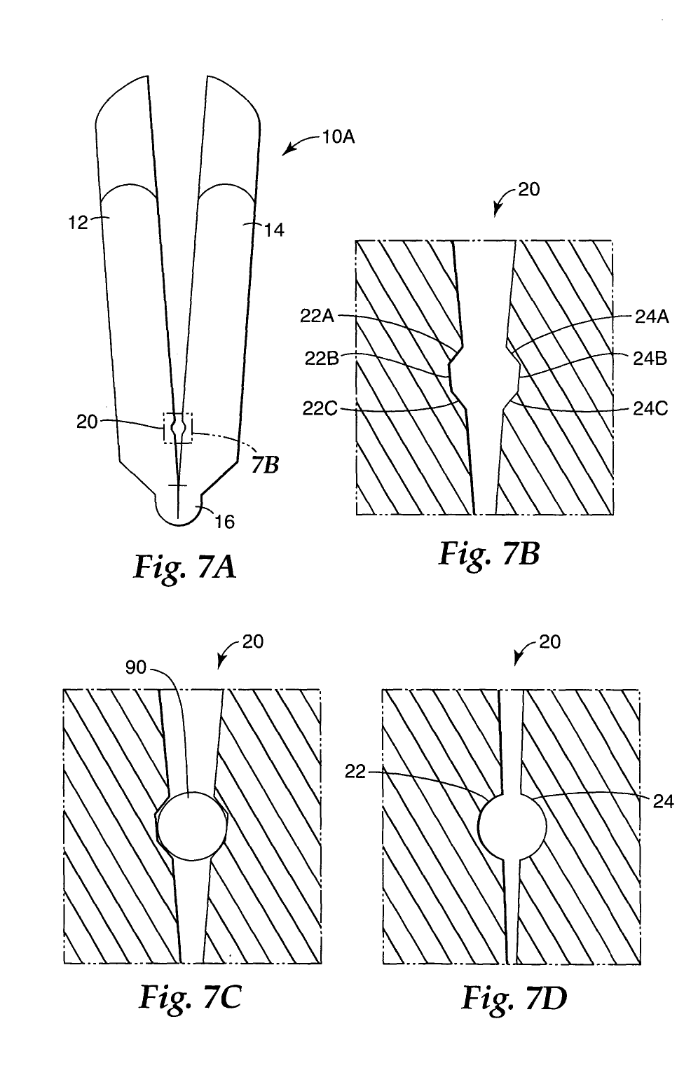

An exemplary pre-grooving process is shown in FIGS. 7A-7D. In FIG. 7A, a gripping device 10A is shown prior to pre-grooving. In this state, gripping region 20 comprises multi-sided forms that can be coined on the interior surfaces of legs 12 and 14, respectively. A close-up schematic view of gripping region 20 is shown in FIG. 7B, with exemplary three-sided form 22A, 22B, and 22B and exemplary three-sided form 24A, 24B, and 24C, prior to pre-grooving. In FIG. 7C, a pre-groove pin is placed between the three-sided forms. The arms of the gripping device are then brought together to a predetermined width, which deforms the three-sided forms, and thus forms substantially semicircular gripping portions 22 and 24, shown in FIG. 7D.

In an exemplary embodiment, a precise diameter pin is used to create the substantially semicircular gripping portions. For example, a pin that has an outer diameter that is the same or slightly larger than the outer diameter of the fiber to be gripped can be utilized. For pins having a smaller diameter than the outer diameter of the fiber, an increase in stress points may occur. If the pin diameter is too much larger than the fiber outer diameter, then stress may be concentrated only on, e.g., the 3 o'clock and 9 o'clock positions of the fiber, relative to a front end view of the fiber. This situation may result in poor fiber-to-fiber alignment and/or higher insertion loss in splicing applications.

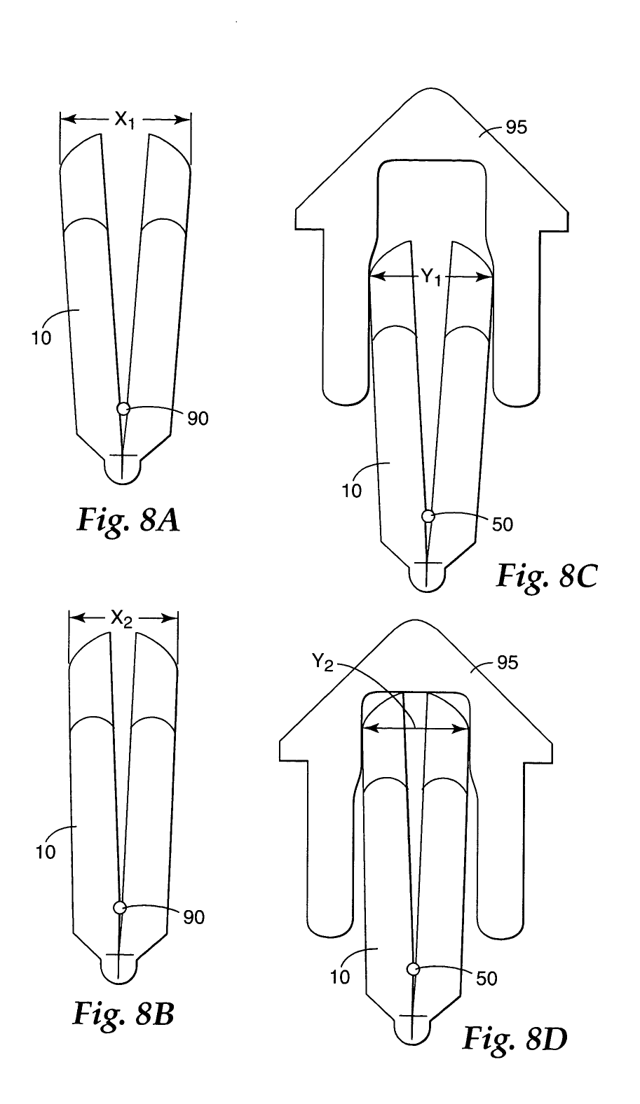

In addition, the dimension selected to close the gripping device around the pre-groove pin can influence the degree of stress that is imparted onto the fiber. As the inventors have determined, the greater the difference in dimensions between the final pre-groove dimension, and the closed/engaged dimension of the gripping device, the greater the stress that can be imparted on the fiber. FIGS. 8A-8D illustrate this principle.

In the exemplary embodiment of FIG. 8A, a pre-groove dimension is set. This dimension can be based on the type of fiber being gripped, spliced, and/or connected, and the physical parameters of the device itself, including its length and thickness. The first position shown in FIG. 8A corresponds to an “open” pre-groove dimension, where the distance between the ends of the legs is set at distance=X1. The pre-groove pin is then inserted in the gripping region and the device is then placed at a “closed” pre-groove position (FIG. 8B), where the distance between the ends of the legs is set at distance=X2. The device 10 is then placed at an “open” gripping/splicing/connecting position, here, at a distance=Y1, shown in FIG. 8C, which allows the fiber to be inserted into the gripping region. A user can then actuate a grip, splice, and or connection, as is shown in FIG. 8D, by closing device 10 to a “closed” gripping/splicing/connecting position, here, at a distance=Y2. An element cap 95 may be utilized to perform this closing process by providing a camming action to urge the legs of the device toward one another. In one exemplary embodiment, the following relationship is utilized: X1>Y1>X2>Y2. Thus, the forms used to locate the pre-groove pin and the closed pre-groove dimension can be varied to alter the amount of stress that is imparted to the outer diameter of the fiber, and optimal compressive forces can be utilized based on the principles discussed herein.

In one example, a steel pre-groove pin having an outer diameter of 0.0049″ (+0.000040″/−0.0″ tolerance) was utilized. The pin was placed in the gripping region, and the gripping device was placed in a closed pre-groove position of 0.054″ (corresponding to the X2 distance). The pin was removed, resulting in semicircular shaped gripping portions. In this example, the X1 distance was 0.64″, the Y1 distance was 0.058″, and the Y2 distance was 0.050.

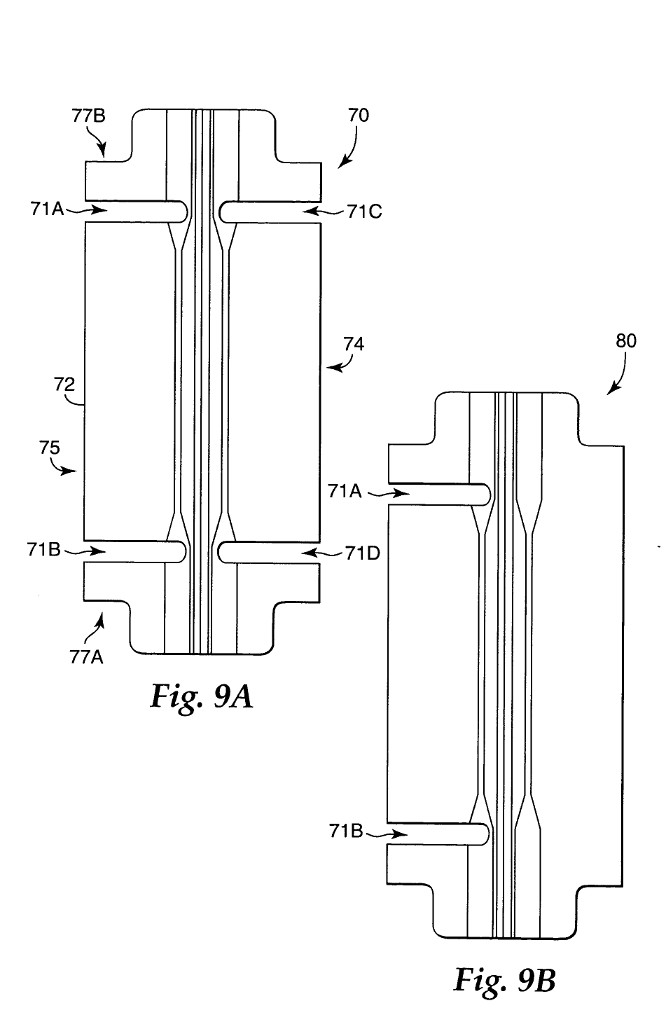

According to another embodiment of the present invention, the gripping device can be tailored to impart a more gradual stress onto the outer diameter of the fiber. FIGS. 9A and 9B show alternative examples of this embodiment. For example, FIG. 9A a gripping device 70 is shown in a top plan view in an unfolded state. Device 70 is similar to that shown in FIG. 3, except that the device 70 further includes a quadruple slot structure (slots 71A, 71B, 71C, and 71D). The slots are used to define three sets of clamping zones (when device 70 is placed in a folded state), where zones 77A and 77B are outer clamping zones and zone 74 is an inner clamping zone. In an alternative embodiment, shown in FIG. 9B, a double slot structure is utilized (including slots 71A and 71B). These configurations allow different levels of stress to be imparted on the fiber that is located in each zone. In exemplary embodiments, a light stress can be utilized for the precise alignment of two fibers in the inner zone, while an increased stress can be imparted onto the fiber in the outer zones to increase fiber retention. The two and four slot arrangements can offer differing strengths, depending on the application. Of course, as will be apparent to one of ordinary skill in the art given the present description, different numbers of slots may also be utilized without departing from the scope of the invention.

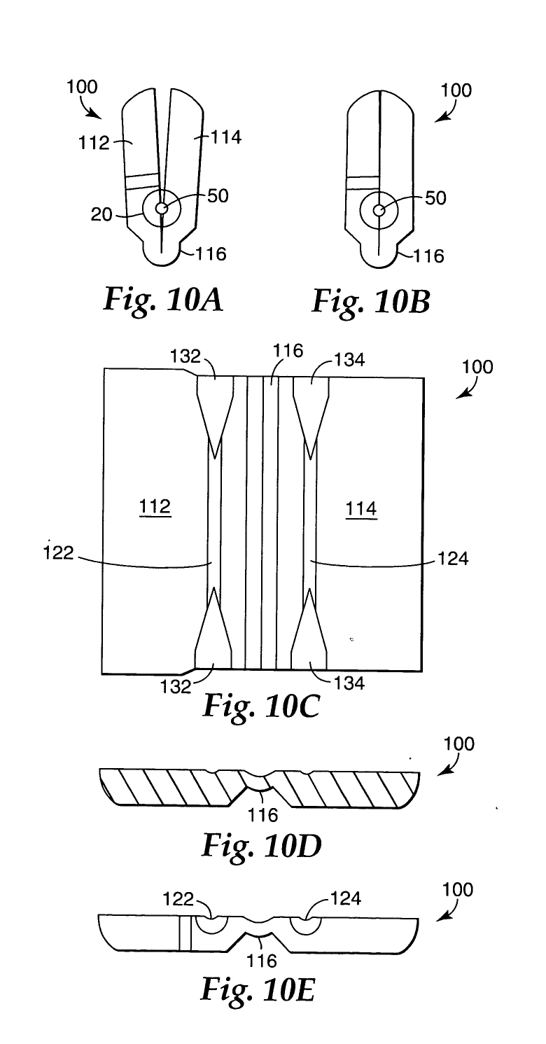

According to another embodiment of the present invention, a fiber gripping/splicing/connecting device can be utilized for adhesiveless connector applications, such as in connection with CRIMPLOK™ fiber optic connectors, described above. For example, FIGS. 10A-10E show a gripping device 100 that can be utilized in a CRIMPLOK™ fiber optic connector. FIGS. 10A and 10B show side elevational views of an optical fiber gripping device 100 that includes legs 112 and 114, a hinge region 116, and a fiber gripping region 120. Hinge region 116 is shown in an unfolded state in FIG. 10D. An optical fiber 50 can be inserted in device 100 when the device 100 is in its open (fiber-receiving) state (FIG. 10A). In its closed state (FIG. 10B), the device 100 can provide substantially even compressive force distribution along the perimeter of the fiber. As shown in FIG. 10C, a top plan view of optical fiber gripping device 100 in an unfolded state, gripping portions 122 and 124 can be provided in accordance with the structure and pre-grooving method described above (see also FIG. 10E, which shows fiber gripping portions 122 and 124 each having a substantially semicircular shape). In addition, recesses 132 and 134 can form a lead-in fiber-receiving region. In addition, as will be apparent to one of ordinary skill in the art given the present description, in alternative embodiments, variations of the gripping devices described herein can be utilized within 4×4 FIBRLOK™ and Multifiber FIBRLOK™ fiber optic devices (commercially available from 3M Company).

Devices using the geometry described above for the gripping region can also be utilized in remateable connecting applications.

In one application of the above described fiber gripping devices, these devices can be utilized to form a connection or splice using protective coated optical fibers, for example a GGP fiber to GGP fiber splice and a GGP to non-GGP fiber splice. Referring back to FIG. 2, a first GGP fiber can be inserted in device 10 (in its fiber receiving state) in fiber receiving section 21A. A second fiber, GGP or non-GGP, can be inserted in fiber receiving section 21B. An index matching fluid (not shown) can be loaded in the gripping region 20 to ensure suitable optical coupling. The fiber ends can be butted to one another, then the device can be placed in its closed (engaged) state to complete the splice. As the exemplary embodiments of the present invention provide an even distribution of compressive force to the fiber(s) located in the gripping region, the reduced deformity of the outer protective coating of such fibers permits suitable direct optical coupling of GGP fibers to each other and a GGP fiber to a non-GGP fiber. In addition, the gripping devices of the present invention can be utilized to provide optical coupling of non-GGP fibers to each other, such as conventional glass-based fibers, POF (Plastic Optical Fiber), and TECS fiber. Thus, exemplary embodiments of the present invention can provide a mechanical splicing tool for splicing, gripping, and/or connecting protective coated fibers and non-protective coated fibers.

Tests were also performed on gripping devices according to the present invention that were used to hold GGP to GGP splices, GGP to glass (SMF—manufactured by Corning Inc., of Corning N.Y.) splices, and SMF to SMF splices. All fibers had an outer diameter of about 125 μm. Regarding initial fiber retention ability, GGP to GGP splices (12 total), GGP to glass (SMF) splices (12 total), and SMF to SMF splices (12 total) each had the average tensile force to failure results of greater than 2 lbs.

In addition, a fiber retention test was made using eight GGP fiber splices made in a gripping device according to the present invention under accelerated environmental conditions. In this test, fiber retention was measured after placing the splices in a chamber where the temperature and humidity were maintained at 85 degrees C. and 95% relative humidity, respectively, for ten days. Also, the gripping portions of the gripping device contacted about 300-310 degrees of the perimeter of the 125 μm GGP fiber being held. All eight GGP fiber splices exhibited fiber retention of 3.3 lbs or greater. As a comparison, ten 125 μm GGP fiber splices were made using v-groove splice devices under these same accelerated environmental conditions. None of the v-groove GGP splices exceeded 1 lbs. fiber retention under these conditions.

As fiber optics are deployed deeper into the metro and access areas of a network, the benefits of such mechanical interconnection products can be utilized for Fiber-To-The-Home/Desk/Building/Business (FTTX) applications. The devices of the present invention can be utilized in installation environments that require ease of use when handling multiple splices and connections, especially where labor costs are more expensive.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

1. An optical fiber gripping device, comprising:
a sheet of material having first and second members hingedly attached at a first end of each of the members; and
a gripping region that includes first and second gripping portions disposed on first and second inner portions of each of said members, respectively to apply a substantially even distribution of force to an outer perimeter of an optical fiber disposed in said gripping region.

2. The device of claim 1, wherein the gripping portion comprises a substantially malleable material.

3. The device of claim 1, wherein said gripping region is pre-grooved.

4. The device of claim 1, wherein each of said gripping portions comprises a semicircular shape.

5. The device of claim 1, wherein when said gripping region is in an open position, passage of an optical fiber is provided, and wherein when said gripping region is in an engaged position, each of said gripping portions is disposed on an outer diameter of said optical fiber.

6. The device of claim 5, wherein said outer diameter is from about 120 μm to about 130 μm.

7. The device of claim 5, wherein said outer diameter is from about 240 μm to about 260 μm.

8. The device of claim 5, wherein said outer diameter is about 900 μm or larger.

9. The device of claim 1, wherein when said gripping region is in an engaged position, the gripping portions contact about 260 degrees to about 360 degrees of a perimeter of the fiber.

10. The device of claim 1, wherein the optical fiber comprises a glass core, a glass cladding, and a polymer-based coating affixed to said cladding.

11. The device of claim 1, wherein the optical fiber has a protective coating that is softer than the material of the gripping portions.

12. The device of claim 1, wherein the sheet of material further comprises at least one slot to define separate clamping zones along a length of said gripping region.

13. The device of claim 1, wherein said gripping region is adapted to grip two optical fibers, wherein at least one of the fibers being gripped comprises a protective layer that is softer than the material of the gripping portions.

14. The optical fiber gripping device of claim 1, wherein said optical fiber gripping device is disposed in a splice device.

15. The optical fiber gripping device of claim 1, wherein said optical fiber gripping device is disposed in a connector.

16. The optical fiber gripping device of claim 1, wherein said optical fiber gripping device is disposed in a remateable connector.

17. An optical fiber splice, comprising:
a first optical fiber having a first end;
a second optical fiber having a second end; and
a housing to support the first and second ends in contact, wherein said housing applies a substantially even distribution of force to an outer perimeter of at least a portion of the first and second optical fibers.

18. The optical fiber splice of claim 17, wherein said housing comprises:
an optical fiber gripping device that includes first and second members hingedly attached at a first end of each of the members; and
a gripping region that includes first and second gripping portions disposed on first and second inner portions of each of said members, respectively to apply said substantially even distribution of force to the outer perimeter of the portions of the first and second optical fibers disposed in said gripping region.

19. The device of claim 18, wherein said gripping region is pre-grooved.

20. The device of claim 18, wherein each of said gripping portions comprises a semicircular shape.

21. The optical fiber splice of claim 17, wherein the first fiber further a glass core, a glass cladding layer, and a protective coating affixed to the cladding layer.

22. The optical fiber splice of claim 21, wherein the protective coating is a polymer-based coating.

23. The optical fiber splice of claim 17, wherein at least on fiber is a plastic optical fiber (POF).

24. The optical fiber splice of claim 17, wherein at least one fiber is a TECS fiber.

25. The optical fiber splice of claim 17, wherein at least one of the fibers is a glass fiber.

26. A method of making an optical gripping device that applies a substantially even distribution of force to an outer perimeter of first and second optical fibers disposed therein, comprising:
providing a predetermined diameter pin, wherein said pin is harder than a material comprising a gripping region of the device;
inserting the pin in said gripping region of the gripping device in a first predetermined position; and
closing the device to a second predetermined position to form substantially semicircle shapes in said gripping region.

27. The method of claim 26, wherein said gripping region comprises first and second gripping portions, each having a multi-sided form prior to said closing.
